(19) United States
(12) Patent Application Publication
(10) Pub. No.: US 2026/0099782 A1
(43) Pub. Date: Apr. 9, 2026

(54) SYSTEM AND METHODS FOR WIRELESS INFRASTRUCTURE UPDATE BASED ON MULTI-DOMAIN INTELLIGENT PREDICTIVE ANALYSIS

(71) Applicant: Congruex Group, LLC, Boulder, CO (US)

(72) Inventors: Herkole Sava, Centreville, VA (US); Michael Seymour, Dallas, TX (US)

(21) Appl. No.: 18/905,733

(22) Filed: Oct. 3, 2024

(51) Int. Cl. G06Q 10/0631

(52) U.S. Cl. CPC G06Q 10/06313

(57) ABSTRACT

A computer system for wireless structure update systems is provided. The computer system programmed to: a) receive a request to update a plurality of sites, including a plurality of update parameters and an area containing the plurality of sites; b) compare the plurality of site information to the plurality of update parameters; c) determine one or more update actions to update each of the plurality of sites based upon the comparison; d) generate clusters for the plurality of sites, wherein each cluster is based upon the travel distances between nearby sites; e) calculate an overall cost for the request to update based upon the determined one or more update actions, the travel distances, and the clusters; f) assign resources to the request to update; g) receive real-time project completion updates; and h) update the assigned resources.

### BACKGROUND

The field of the disclosure relates generally to wireless structure update systems, and more particularly, to systems and methods for controlling wireless infrastructure updates using multi-domain intelligent predictive analysis.

Wireless Infrastructure modification and upgrades are a major activity for mobile wireless operators and the entire ecosystem serving this segment of the industry. Based on historical data, every ten years a new generation of wireless systems is defined by 3GPP (3rd Generation Partnership Project). These new definitions have required substantive changes and/or upgrades to the radios and antennas positioned on wireless towers or other structures. These changes are due to the deployment of new frequency bands as well as new wireless technologies (e.g., Massive MIMO (multiple input, multiple output) systems) that would require removal and replacement of existing systems and/or the addition of new radios and antennas on those structures. Furthermore, mobile wirelesses operators upgrade their radios and antennas as part of their technological evolution even within a major 3GPP standard release, to leverage advancements in multi-frequency band radio designs, improve performance of radios related to energy conservation, and/or take advantage of other industry initiatives like Open-RAN (radio access network) architecture, etc. The scale of such network upgrades/changes are very extensive as mobile operators in the USA and abroad own, or operate, tens of thousands of radio mounts installed on wireless towers. For instance, in 2022, a tier-1 mobile wireless operator in the USA had to upgrade up to 1,000 sites per week in order to meet their 5G deployment business objectives.

Therefore, designing, managing, and executing such wireless network infrastructure updates is a very complex and costly exercise which is a very labor-intensive activity, as it requires deployment of specialized and licensed crews to install radios/antennas on a range of structures from wireless towers that are hundreds of feet high in rural towns to small cell monopoles located in high density urban thoroughfares.

To date, most wireless network upgrade activities are mainly driven by availability of radio equipment from OEMs and basic project planning of available resources to carry out those upgrades. However, such an approach may lead to non-optimal operations that could substantially affect wireless tower site services for unpredicted amount of times, which, in turn, may increase unduly the cost of wireless network upgrades/changes. Furthermore, current wireless infrastructure network upgrades/changes do not consider key data from various other domains that may be key ingredients to an optimal, timely executed, and cost-effective process that could lead to substantive savings to mobile network operators. Accordingly, a system that takes a comprehensive approach on intelligent designing and real-time adaptation of optimal wireless infrastructure mass scale upgrades/changes would be desirable.

### BRIEF DESCRIPTION

In one aspect, a computer device for wireless structure update systems is provided. The computer system including at least one processor in communication with at least one memory device. The at least one processor is programmed to: a) store a plurality of site information; b) receive a request to update a plurality of sites, including a plurality of update parameters and an area containing the plurality of sites; c) retrieve a plurality of site information for the plurality of sites; d) compare the plurality of site information to the plurality of update parameters; e) determine one or more update actions to update each of the plurality of sites based upon the comparison; f) calculate travel distance between nearby sites in the plurality of sites; g) generate clusters for the plurality of sites, wherein each cluster is based upon the travel distances between nearby sites; h) calculate an overall cost for the request to update based upon the determined one or more update actions, the travel distances, and the clusters; i) assign resources to the request to update based upon the overall cost, the determined one or more update actions, the travel distances, and the clusters; j) receive real-time project completion updates; and k) update the assigned resources based upon the real-time project updates. The computer device may direct additional, less, or alternate functionality, including that discussed elsewhere herein.

In another embodiment, a computer-implemented method for wireless structure update systems is provided. The method implemented by a computer system including at least one processor in communication with at least one memory device. The method includes a) storing a plurality of site information; b) receiving a request to update a plurality of sites, including a plurality of update parameters and an area containing the plurality of sites; c) retrieving a plurality of site information for the plurality of sites; d) comparing the plurality of site information to the plurality of update parameters; e) determining one or more update actions to update each of the plurality of sites based upon the comparison; f) calculating travel distance between nearby sites in the plurality of sites; g) generating clusters for the plurality of sites, wherein each cluster is based upon the travel distances between nearby sites; h) calculating an overall cost for the request to update based upon the determined one or more update actions, the travel distances, and the clusters; i) assigning resources to the request to update based upon the overall cost, the determined one or more update actions, the travel distances, and the clusters; j) receiving real-time project completion updates; and k) updating the assigned resources based upon the real-time project updates. The method may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIGS. 1A and 1B illustrate a process for predictive analysis for network upgrades in accordance with at least one embodiment.

FIGS. 2A and 2B illustrate another process for predictive analysis for network upgrades in accordance with at least one embodiment.

FIG. 3 illustrates an exemplary network environment for the processes shown in FIGS. 1 and 2.

FIG. 4 illustrates a simplified block diagram of an exemplary computer system for the processes shown in FIGS. 1 and 2.

FIG. 5 illustrates an exemplary configuration of a client computer device shown in FIG. 4, in accordance with one embodiment of the present disclosure.

FIG. 6 depicts an exemplary configuration of a server computer device, in accordance with one embodiment of the present disclosure.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present embodiments may relate to, inter alia, an innovative design and configuration for controlling wireless infrastructure updates using multi-domain intelligent predictive analysis. The systems and methods presented in this disclosure describe a comprehensive approach on intelligent designing and real-time adaptation of optimal wireless infrastructure mass scale upgrades/changes based on intrinsic network data traffic patterns, optimally mapping wireless sites in daily clusters of operations based on their proximity, amount of time to perform respective upgrades/changes and availability of resources while taking into account weather and climate factors that may impact such operations.

In the exemplary embodiment, the system is instructed to estimate the cost of performing the changes in the defined geographic area. In some embodiments, the system also determines what resources area available in the geographic region, when is the best optimum time to perform the upgrades, how long the upgrades will take to perform, how long it will take to perform the upgrades, and/or how much it will cost to perform the upgrades.

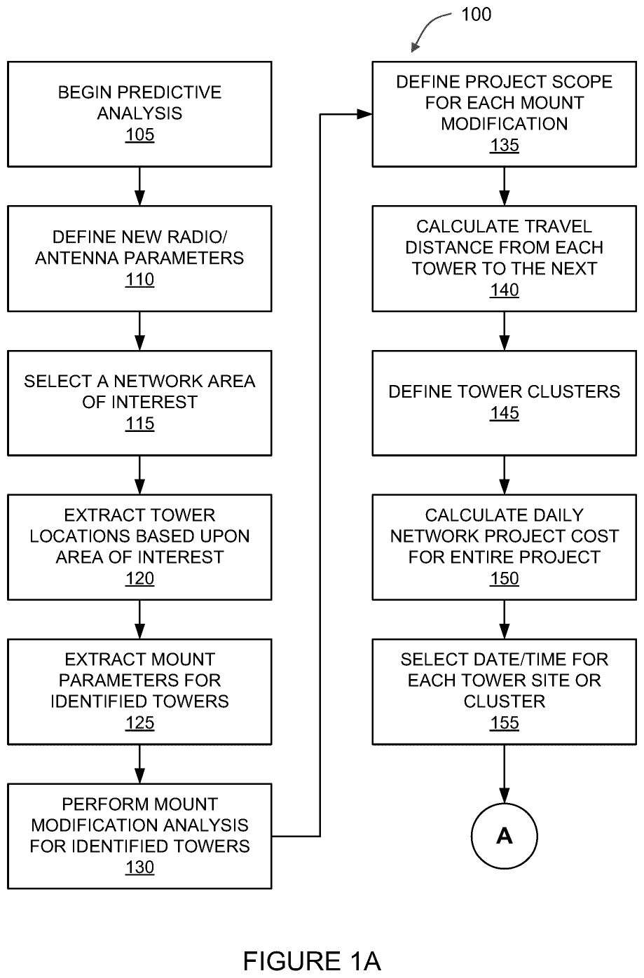

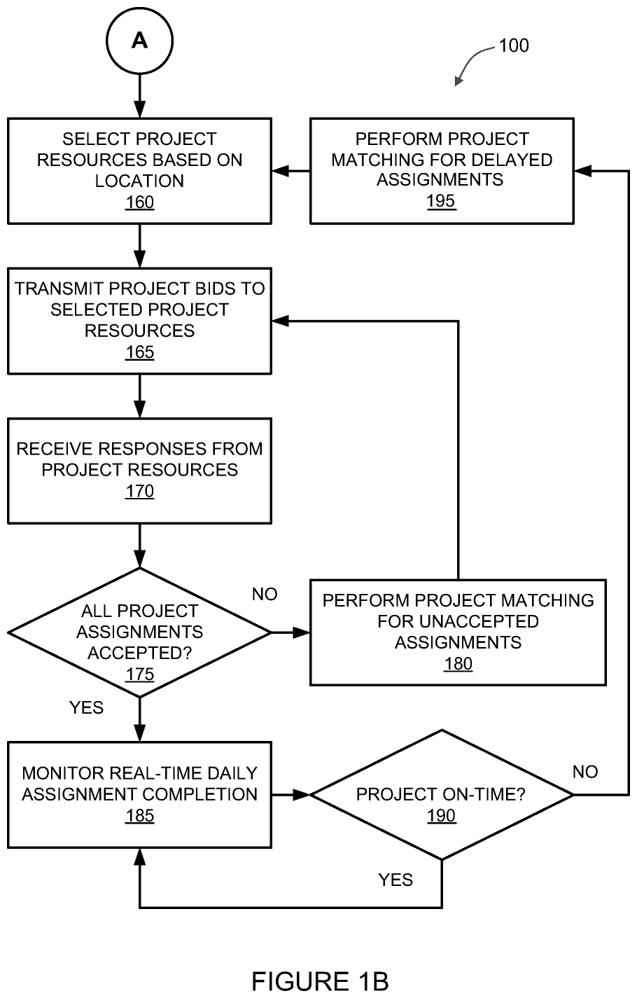

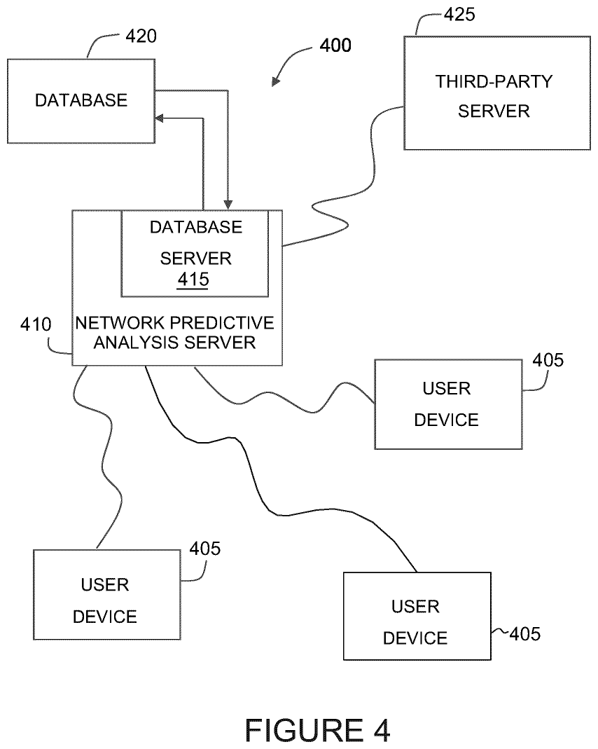

FIGS. 1A and 1B illustrate a process 100 for predictive analysis for network upgrades in accordance with at least one embodiment. In the exemplary embodiment, the steps of process 100 are performed by the network predictive analysis (NPA) computer device 410 (shown in FIG. 4).

Prior to executing a network upgrade, the user instructs the NPA computer device 410 to begin 105 a predictive analysis to quantify the scale, timing, resources, locations, and dependencies of such operations on the network. The user and/or the system define 110 the parameters of the new radios/antennas such as dimensions (e.g., length, width, depth, weight, etc.) to define the scope of changes required. Furthermore, additional constraints in terms of radio replacement or addition could be inputted into the system. In the exemplary embodiment, the input parameters are provided from one or more network operators, such as mobile network operators. In some embodiments, the input parameters are provided as one or more statements of work. The network operator also provides location information by selecting 115 a network area of interest. The desired area of network upgrades may be provided in the form of a geofence is also defined as an input into the predictive analysis. This could be a country geographical area, market segment definition, region, city, or detailed list of sites under consideration. Other possible definitions are also possible. For example, the network update could be for the Northwest of the United States, or any other geographic region that the user desires. In some embodiments, the geographic region could be for a single city, metropolitan area, or portion thereof. In other embodiments, the geographic region could be as large a country or group of countries. In some embodiments, the user defines a geofence around the desired geographic region.

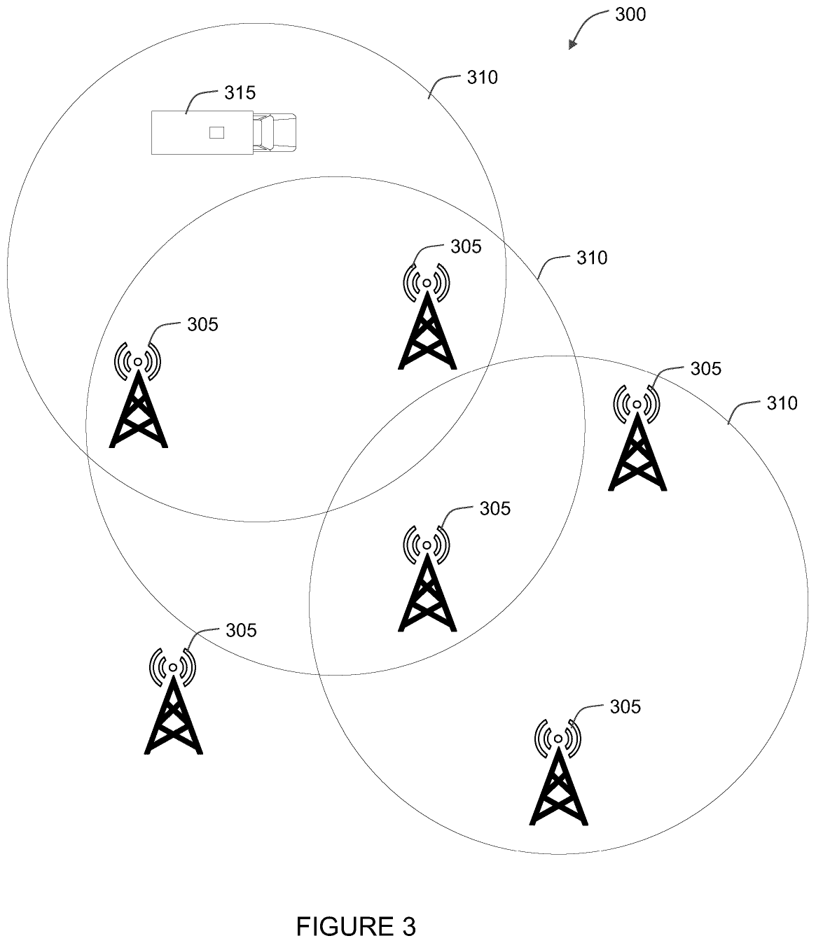

In the exemplary embodiment, the NPA computer device 410 accesses one or more databases 420 (shown in FIG. 4) to retrieve or extract 120 the locations of all of the towers 305 (shown in FIG. 3) in the defined area of interest. In the exemplary embodiment, the NPA computer device 410 extracts 120 from the database 420 the exact locations of those wireless towers 305 where the upgrades need to be carried out. The NPA computer device 410 also extracts 125 mount parameters for the identified towers 305. These parameters include all the equipment and mount structural information relevant to those radio/antenna changes/upgrades. In some embodiments, the NPA computer device 410 extracts 120 and 125 the data from an existing database 420. In other embodiments, such information is extracted 120 and 125 through the use of Generative AI (artificial intelligence) technologies as much of such information exists in the public domain.

In the exemplary embodiment, the NPA computer device 410 performs 130 mount modification analysis for the identified towers 305. This step analyses the current mount structures and the impact of the new radio/antennas'changes/additions on those structures in order to define the scope of projects per each site. The NPA computer device 410 determines the current mounts on each of the towers 305 and calculates the amount of work that needs to be done for each tower 305. For example, there may be a newer mount in place because the old mount broke or there may be a really old mount that has not been upgraded in a long time. The NPA computer device 410 determines whether or not the current mount needs replacement and/or modification based upon the new radio/antenna parameters. In some embodiments, this step is handled through a machine learning algorithm that automatically predicts the impact of new radio/antennas on the mount structure and the scope of modification/change required to support such change.

Upon completion of Step 130 for all the wireless tower sites, or other structures under analysis, the NPA computer device 410 defines 135 the scope of those respective projects in terms of time, cost, resources, etc. In some embodiments, this is made possible through data mining of similar past projects stored on the database(s) 420. In these embodiments, database(s) 420 contain detailed information about past projects not only on cost, time of project completion, resources, but also project dependencies on other activities, auxiliary equipment, location specific data, etc.

In the exemplary embodiment, the NPA computer device 410 calculates 140 travel distances from each tower 305 to the next nearby tower(s) 305. In some embodiments, the NPA computer device 410 calculates 140 travel distances to every tower 305 within a predetermined distance from each other tower 305. In this step, the NPA computer device 410 calculates 140 the first and second order distance from each tower 305 to its neighboring towers 305. Such information is important to define a cluster of towers 305 that can allow for optimal daily execution of multiple projects in a single day in multiple locations assuming that time of project completion and travel between sites fits under the total working day hours. Such an approach leads to minimal disruption of tower services while ensuring optimal assignment and distribution of workforce to carry out the work.

Then the NPA computer device 410 uses those travel distances to define 145 tower clusters 310 (shown in FIG. 3). The tower clusters 310 are groups of clusters 310 than can be upgraded in a workday, such as a period of 8 hours, etc. The NPA computer device 410 considers the amount of time calculated to update each tower 305 as calculated in Step 135. For example, if each crew 315 (shown in FIG. 3) has eight hours a day, the system doesn't want to send a crew 315 to a first tower 305 now and another tower 305 that needs updates that is three hours away, and the crew 315 has to do four hours of work at the first tower 305 and five hours at the second tower 305. The crew 315 won't be able to finish it within the day, which would lead to more downtime etc. The system wants to find the clusters 310 so that 2 to 3 towers 305 may be upgraded in the workday, while taking into account, the necessary travel time. This greatly increases the efficiency of the operation of the crew 315 and prevents extended downtime for updates that need to take place over multiple days due to timing, but could be performed in a single day.

The NPA computer device 410 calculates 150 the daily network project cost for the entire project. The NPA computer device 410 calculates 150 the daily project update cost over the total period of project completion. This is the optimal project completion cost and plan. The overall project cost is calculated as well as the length of time to complete the network upgrade/change. This is made possible by matching local available resources to the defined scope and location of work. If the timeframes have to be changed (i.e., more aggressive), then this step can perform sensitive predictive analysis on time/cost/length project parameters.

The NPA computer device 410 selects 155 the best date/time to execute the wireless site projects for each tower site or cluster based upon historical weather conditions, current weather predictions, and daily site data tonnage distribution. As the majority of wireless network infrastructure upgrades are conducted in outdoor locations, and challenging heights with heavy equipment, such work can only be conducted when weather condition permits. Therefore, the daily assignments of those tasks can be better served by inputting weather conditions and patterns as parameters to the predictive analysis. Step 155 allows the site to be served, when possible, with as minimal interruption as possible. Furthermore, the selection of the working time on a site is best matched with the time when the lowest tonnage (data usage or bandwidth) per period project time exists on the respective site. The tonnage on a wireless side varies per hours. For example, the tonnage for a tower 305 may be very low between the hours of 9 AM and 2 PM, and then the tonnage increases between 2 PM and 5 PM with a peak from 5 PM to 11 PM. Then the system would like to ensure that the tower 305 is updated during those low tonnage hours to reduce costs. Such optimization allows for minimal customer service interruption as well reduces to a maximum roaming costs to the wireless network operator due to the interruption of service as a result of radio/antenna installation on the site. In some embodiments, Step 155 is a multi-factor optimization provided using a machine learning predictive analysis methodology. In some embodiments, the cost optimization is from the point of view of the network operator to save them the cost for roaming fees or customer satisfaction while the tower 305 is being updated. Furthermore, the system is not constrained by normal working out, but may suggest crews 315 work between 6 PM and 2 AM on some towers 305 due to the tonnage for those towers 305 at those and other times.

The NPA computer device 410 selects 160 project resources based upon location. This step performs a default mapping of project available resources to project tasks assuming their 100% availability, which may or may not be the case as those resources may be independent companies and contractors working on other assignments as well. Then the NPA computer device 410 transmits 165 project bids to selected project resources and receives 170 their responses. The project plan is sent to all selected resources in Step 160 and their feedback/answers 170 is received. Those answers 170 may or may not align with the original project plan due to resource availability, cost considerations, or any other impending factors. The responses 170 may include acceptance of some of the bids/assignments and refusal for others. Some of the responses 170 may also include further availability information, such as alternative date/time suggestions, potential additional costs, etc.

The NPA computer device 410 determines 175 if all of the project bid/assignments were accepted. If all of the project bid/assignments were accepted, then the NPA computer device 410 continues on to Step 185. Otherwise, the NPA computer device 410 performs 180 project matching for unaccepted bids/assignments. If there is not a total match between the preliminary optimized project plan and response from desired resources, the NPA computer device 410 performs 180 a multi-domain, multi-factor optimization predictive analysis. In most situations, the most likely outcome of Step 175 is a non-total match for a multitude of factors. The NPA computer device 410 conducts 180 a multi-domain data predictive analysis combining inputs from all the projects factors (e.g., scope of work, length of work, location, cost, resource availability, weather, data tonnage on the site, etc.) to find solution for the unassigned projects per Step 175. In addition, a sensitivity analysis is performed on this multi-factor/domain analysis to allow the project owner to select the best path forward. In some embodiments, this selection may be automated based upon previously inputted criteria and/or preferences from the project owner or other user. In some embodiments, this analysis is performed only on the non-accepted bids/assignments. In other embodiments, this analysis is performed on all bids/assignments. And in further embodiments, the analysis is performed on some of the accepted and all of the unaccepted bids/assignments. Based upon this additional analysis, the NPA computer device 410 returns to Step 165. This loop continues until all project bids/assignments have been accepted.

Once all project bids/assignments have been accepted, the NPA computer device 410 begins monitoring 185 real-time daily assignment completion. Did the crew 315 finish the updates that they were scheduled to? Did something happen, weather, traffic, other, that prevented them from completing all of their scheduled updates. The NPA computer device 410 determines 190 whether or not the project is on-time based upon the monitoring 185. If everything is still on-time, the NPA computer device 410 continues monitoring 185. If the project is no longer on-time, such as because one or more updates were not performed, then the NPA computer device 410 performs 190 project matching for the delayed assignments and returns to Step 160 for the delayed assignments. The NPA computer device 410 continues process 100 until the project is complete. In some further embodiments, the NPA computer device 410 generates one or more reports. In some embodiments, the reports are generated on a period basis as well as at the completion of the project. In information about the project is then stored in the one or more databases 420 and then used for future projects.

While the above method is described for a tower for wireless networks. One having skill in the art would understand that the systems and methods described herein may be used with building and/or upgrading other types of structures and/or equipment as desired.

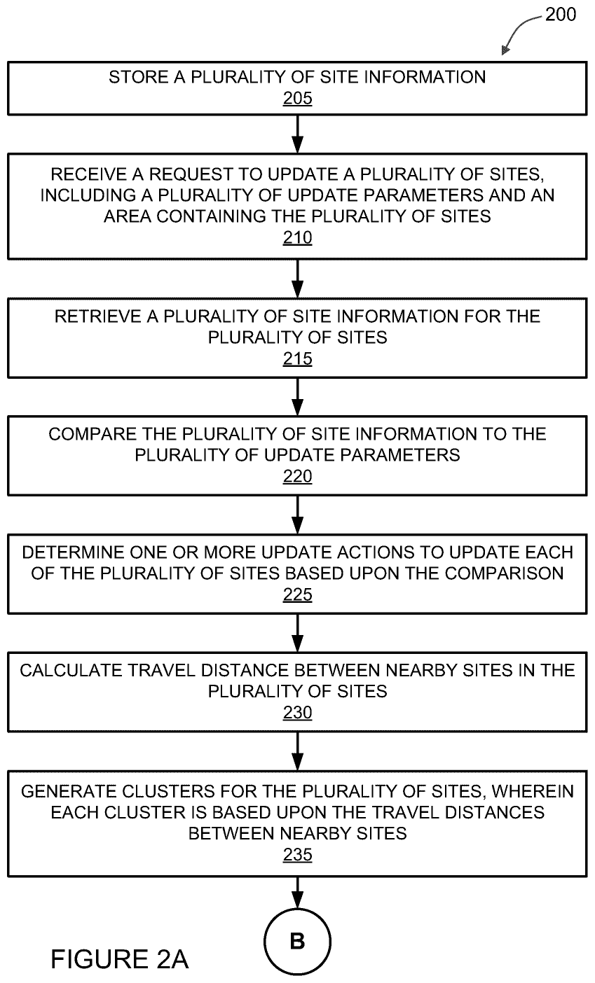

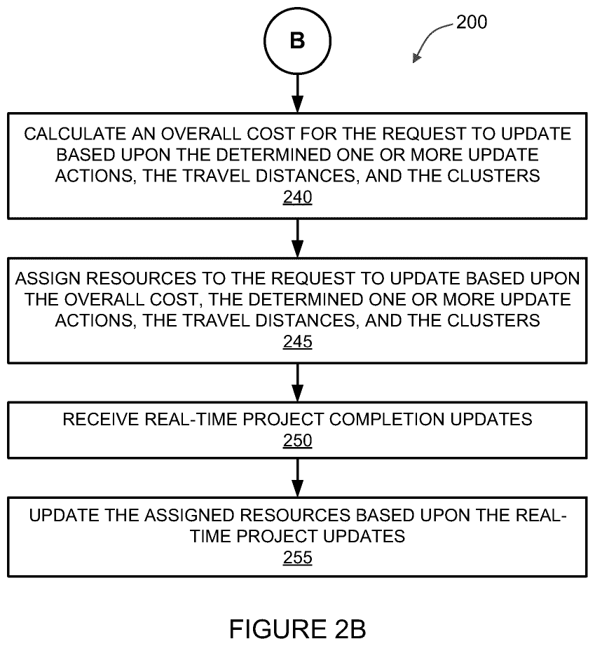

FIGS. 2A and 2B illustrate another process 200 for predictive analysis for network upgrades in accordance with at least one embodiment. In the exemplary embodiment, the steps of process 200 are performed by the network predictive analysis (NPA) computer device 410 (shown in FIG. 4).

In the exemplary embodiment, the NPA computer device 410 stores 205 a plurality of site information. The site information may include locations of the sites 305) (shown in FIG. 3) and parameters of the sites 305. In the telecom tower embodiment, the parameters may include information about the mounts available on the towers 305. In the exemplary embodiment, the plurality of site information is stored in one or more databases 420 (shown in FIG. 4).

In the exemplary embodiment, the NPA computer device 410 receives 210 a request to update a plurality of sites 305, including a plurality of update parameters and an area containing the plurality of sites 305. The update parameters include information about new equipment such as dimensions (e.g., length, width, depth, weight, etc.) to define the scope of changes required. In the exemplary embodiment, the equipment is new radios/antennas for telecom towers 305. The area may include any geographic area. This could be a country geographical area, market segment definition, region, city, or detailed list of sites 305 under consideration. Other possible definitions are also possible. For example, the network update could be for the Northwest of the United States, or any other geographic region that the user desires. In some embodiments, the geographic region could be for a single city, metropolitan area, or portion thereof. In other embodiments, the geographic region could be as large a country or group of countries. In some embodiments, the user defines a geofence around the desired geographic region.

In the exemplary embodiment, the NPA computer device 410 retrieves 215 a plurality of site information for the plurality of sites 305. In the exemplary embodiment, the NPA computer device 410 retrieves 215 the data from the one or more databases 420. The plurality of site information includes the exact locations of the sites 305. These parameters include all the equipment and mount structural information relevant to those changes/upgrades, such as for the radios/antennas.

In the exemplary embodiment, the NPA computer device 410 compares 220 the plurality of site information to the plurality of update parameters. In the exemplary embodiment, the NPA computer device 410 determines 225 one or more update actions to update each of the plurality of sites 305 based upon the comparison. Steps 220 and 225 analyze the current structures and the impact of the new changes/additions on those structures in order to define the scope of projects per each site 305. The NPA computer device 410 determines the current equipment on each of the sites 305 and calculates the amount of work that needs to be done for each site 305. For example, there may be newer equipment in place because the old equipment broke or there may be a really old equipment that has not been upgraded in a long time. The NPA computer device 410 determines whether or not the current equipment needs replacement and/or modification based upon the new parameters. In some embodiments, this step is handled through a machine learning algorithm that automatically predicts the impact of new equipment on the structure of the site and the scope of modification/change required to support such change.

In the exemplary embodiment, the NPA computer device 410 calculates 230 travel distance between nearby sites in the plurality of sites. In some embodiments, the NPA computer device 410 calculates 230 travel distances to every site 305 within a predetermined distance from each other site 305. In this step, the NPA computer device 410 calculates 230 the first and second order distance from each tower 305 to its neighboring towers 305. Such information is important to define a cluster 310 (shown in FIG. 3) of sites 305 that can allow for optimal daily execution of multiple projects in a single day in multiple locations assuming that time of project completion and travel between sites 305 fits under the total working day hours. Such an approach leads to minimal disruption of services while ensuring optimal assignment and distribution of workforce to carry out the work.

In the exemplary embodiment, the NPA computer device 410 generates 235 clusters for the plurality of sites, wherein each cluster is based upon the travel distances between nearby sites. The site clusters 310 are groups of clusters 310 than can be upgraded in a workday, such as a period of 8 hours, etc. The NPA computer device 410 considers the amount of time calculated to update each site 305 as calculated in Step 230. For example, if each crew 315 (shown in FIG. 3) has eight hours a day, the system doesn't want to send a crew 315 to the first site 305 now and another site 305 that needs updates that is three hours away, and the crew 315 has to do four hours of work at the first site 305 and five hours at the second site 305. The crew 315 won't be able to finish it within the day, which would lead to more downtime etc. The system wants to find the clusters 310 so that 2 to 3 sites may be upgraded in the workday, while taking into account, the necessary travel time.

In the exemplary embodiment, the NPA computer device 410 calculates 240 an overall cost for the request to update based upon the determined one or more update actions, the travel distances, and the clusters 310. The NPA computer device 410 calculates 240 the daily project cost for the entire project. The NPA computer device 410 calculates 240 the daily project update cost over the total period of project completion. This is the optimal project completion cost and plan. The overall project cost is calculated as well as the length of time to complete the upgrade/change. This is made possible by matching local available resources to the defined scope and location of work. If the timeframes have to be changed (i.e., more aggressive), then this step can perform sensitive predictive analysis on time/cost/length project parameters.

In the exemplary embodiment, the NPA computer device 410 assigns 245 resources to the request to update based upon the overall cost, the determined one or more update actions, the travel distances, and the clusters 310. This step performs a default mapping of project available resources to project tasks assuming their 100% availability, which may or may not be the case as those resources may be independent companies and contractors working on other assignments as well.

In the exemplary embodiment, the NPA computer device 410 receives 250 real-time project completion updates. Did the crew 315 finish the updates that they were scheduled to? Did something happen, weather, traffic, other, that prevented them from completing all of their scheduled updates. The NPA computer device 410 determines whether or not the project is on-time based upon the monitoring. If everything is still on-time, the NPA computer device 410 continues monitoring.

In the exemplary embodiment, the NPA computer device 410 updates 255 the assigned resources based upon the real-time project updates. If the project is no longer on-time, such as because one or more updates were not performed, then the NPA computer device 410 performs project matching for the delayed assignments and updates 255 the assigned resources.

In some further embodiments, the NPA computer device 410 stores a plurality of historical project information, such as in databases 420. The NPA computer device 410 calculates an overall cost for the request to update based upon the determined one or more update actions, the travel distances, the clusters 310, and the plurality of historical project information. The NPA computer device 410 may also include one or more weather predictions in the calculation of the overall cost.

In some further embodiments, the NPA computer device 410 determines a delayed assignment based upon the real-time project completion updates. The NPA computer device 410 selects a different project resource to compete the delayed assignment.

In some further embodiments, the NPA computer device 410 transmits assignments to the resources. The NPA computer device 410 receives responses from the resources. The NPA computer device 410 may also determine one or more assignments that are declined based upon the responses from the resources. Then the NPA computer device 410 reassigns the one or more declined assignments.

In some further embodiments, the one or more update actions include at least one of replacing, modifying, and reinforcing existing equipment at the site 305.

In some further embodiments, each cluster is based upon the travel distances between nearby sites 305 so that a crew 315 is able to update two or more sites 305 in a single workday.

In some further embodiments, a time for each update is based upon usage amounts for the site 305 at different times of day.

In some further embodiments, the plurality of sites 305 are a plurality of wireless towers 305. The plurality of site information includes information about mounts and equipment at the sites.

FIG. 3 illustrates an exemplary network environment 300 for the processes 100 and 200 (shown in FIGS. 1A, 1B, and 2). In environment 300, there are a plurality of towers 305, such as those to be updated. The towers 305 are assigned to different clusters 310 based upon travel distances, update time, and other factors as described herein. The crews 315 are assigned to the different clusters 310 to update the towers 305 in those clusters 310.

FIG. 4 illustrates an exemplary computer system 400 for performing the processes 100 and 200 (shown in FIGS. 1A, 1B, and 2). In the exemplary embodiment, the system 400 is used for controlling wireless infrastructure updates using multi-domain intelligent predictive analysis.

As described below in more detail, the network predictive analysis (NPA) computer device 410 may be programmed to for controlling wireless infrastructure updates using multi-domain intelligent predictive analysis. In addition, the NPA computer device 410 may be programmed to train artificial intelligence to be used in predictive analysis. In some embodiments, the NPA computer device 410 may be programmed to a) store a plurality of site information; b) receive a request to update a plurality of sites 305 (shown in FIG. 3), including a plurality of update parameters and an area containing the plurality of sites 305; c) retrieve a plurality of site information for the plurality of sites 305; d) compare the plurality of site information to the plurality of update parameters; e) determine one or more update actions to update each of the plurality of sites based upon the comparison; f) calculate travel distance between nearby sites in the plurality of sites 305; g) generate clusters 310 (shown in FIG. 3) for the plurality of sites 305, wherein each cluster 310 is based upon the travel distances between nearby sites 305; h) calculate an overall cost for the request to update based upon the determined one or more update actions, the travel distances, and the clusters 310; i) assign resources to the request to update based upon the overall cost, the determined one or more update actions, the travel distances, and the clusters 310; j) receive real-time project completion updates; and k) update the assigned resources based upon the real-time project updates.

In the example embodiment, user devices 405 are computers that include a web browser or a software application, which enables user devices 405 to communicate with NPA computer device 410 using the Internet, a local area network (LAN), or a wide area network (WAN). In some embodiments, the user devices 405 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. User devices 405 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

In the example embodiment, the NPA computer device 410 (also known as NPA server 410) is a computer that include a web browser or a software application, which enables NPA computer device 410 to communicate with user devices 405 using the Internet, a local area network (LAN), or a wide area network (WAN). In some embodiments, the NPA computer device 410 is communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. NPA computer device 410 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

A database server 415 is communicatively coupled to a database 420 that stores data. In one embodiment, the database 420 is a database that includes network equipment information and/or historical mount analysis data. In some embodiments, the database 420 is stored remotely from the NPA computer device 410. In some embodiments, the database 420 is decentralized. In the example embodiment, a person can access the database 420 via the user devices 405 by logging onto NPA computer device 410.

Third-party servers 425 may be any third-party server to provide information that NPA computer device 410 is in communication with that provides additional functionality and/or information to NPA computer device 410. For example, third-party server 425 may provide weather and climate forecasting information for different geographic regions. In the example embodiment, third-party servers 425 are computers that include a web browser or a software application, which enables third-party servers 425 to communicate with NPA computer device 410 using the Internet, a local area network (LAN), or a wide area network (WAN).

In some embodiments, the third-party servers 825 are communicatively coupled to the Internet through many interfaces including, but not limited to, at least one of a network, such as the Internet, a LAN, a WAN, or an integrated services digital network (ISDN), a dial-up-connection, a digital subscriber line (DSL), a cellular phone connection, a satellite connection, and a cable modem. Third-party servers 425 can be any device capable of accessing a network, such as the Internet, including, but not limited to, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), MR (mixed reality), or XR (extended reality) headsets or glasses), chat bots, voice bots, ChatGPT bots or ChatGPT-based bots, or other web-based connectable equipment or mobile devices.

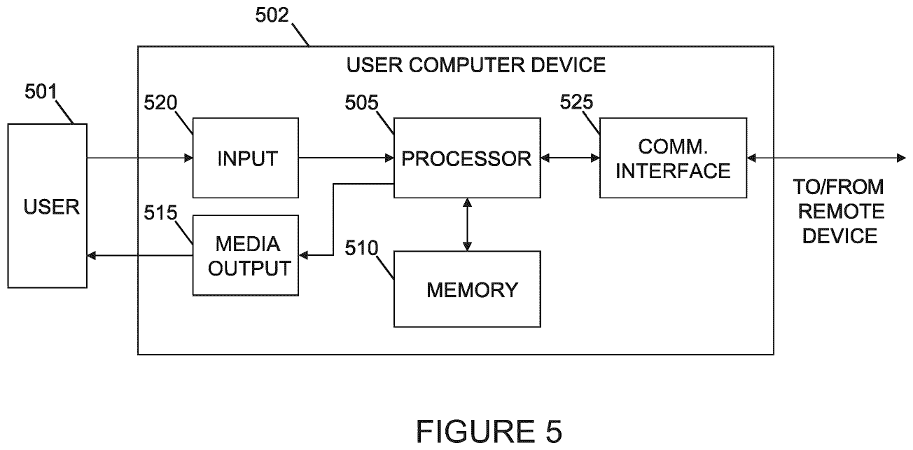

FIG. 5 depicts an exemplary configuration 500 of user computer device 502, in accordance with one embodiment of the present disclosure. In the exemplary embodiment, user computer device 502 may be similar to, or the same as, user device 405 (shown in FIG. 4). User computer device 502 may be operated by a user 501.

User computer device 502 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for viewing items of information provided by the NPA computer device 410 (shown in FIG. 4). In some embodiments, user computer device 502 may include an input device 520 for receiving input from user 501. User 501 may use input device 520 to, without limitation, provide information either through speech or typing.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as NPA computer device 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from NPA computer device 410. A client application may allow user 501 to interact with, for example, NPA computer device 410. For example, instructions may be stored by a cloud service, and the output of the execution of the instructions sent to the media output component 515.

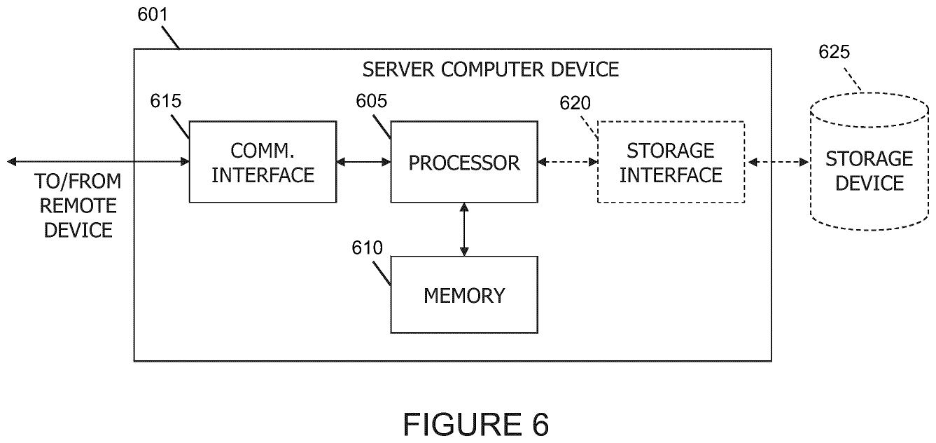

FIG. 6 depicts an exemplary configuration 600 of a server computer device 601, in accordance with one embodiment of the present disclosure. In the exemplary embodiment, server computer device 601 may be similar to, or the same as, NPA computer device 410, database server 415, and third-party server 425 (all shown in FIG. 4). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, NPA computer device 410, third-party servers 425, and user devices 405 (shown in FIG. 4) (for example, using wireless communication or data transmission over one or more radio links or digital communication channels). For example, communication interface 615 may receive input from user devices 405 via the Internet, as illustrated in FIG. 4.

Processor 605 may also be operatively coupled to a storage device 625. Storage device 625 may be any computer-operated hardware suitable for storing and/or retrieving data, such as, but not limited to, data associated with one or more models. In some embodiments, storage device 625 may be integrated in server computer device 601. For example, server computer device 601 may include one or more hard disk drives as storage device 625.

In other embodiments, storage device 625 may be external to server computer device 601 and may be accessed by a plurality of server computer devices 601. For example, storage device 625 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 625 via a storage interface 620. Storage interface 620 may be any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIGS. 1 and 2.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, NPA computer device 410 is configured to implement machine learning, such that NPA computer device 410 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images, text data, and/or other types of data. ML outputs may include, but are not limited to identified objects, items classifications, textual product, and/or other data extracted from the images or textual data. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of text with known characteristics or features. Such information may include, for example, information associated with a plurality of text of a plurality of different towers, mounts, and/or radios.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify tower clusters and patterns that may then be applied to determining assignments. The processing element may also learn how to identify attributes of different towers and assignments. This information may be used to determine which towers to cluster together.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS′ include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for wireless structure update systems, the computer system including at least one processor in communication with at least one memory device, the at least one processor programmed to:
store a plurality of site information;
receive a request to update a plurality of sites, including a plurality of update parameters and an area containing the plurality of sites;
retrieve a plurality of site information for the plurality of sites;
compare the plurality of site information to the plurality of update parameters;
determine one or more update actions to update each of the plurality of sites based upon the comparison;
calculate travel distance between nearby sites in the plurality of sites;
generate clusters for the plurality of sites, wherein each cluster is based upon the travel distances between nearby sites;
calculate an overall cost for the request to update based upon the determined one or more update actions, the travel distances, and the clusters;
assign resources to the request to update based upon the overall cost, the determined one or more update actions, the travel distances, and the clusters;
receive real-time project completion updates; and
update the assigned resources based upon the real-time project updates.

2. The computer system of claim 1, wherein the at least one processor is further programmed to:
store a plurality of historical project information; and
calculate an overall cost for the request to update based upon the determined one or more update actions, the travel distances, the clusters, and the plurality of historical project information.

3. The computer system of claim 2, wherein the at least one processor is further programmed to include one or more weather predictions in the calculation of the overall cost.

4. The computer system of claim 1, wherein the at least one processor is further programmed to:
determine a delayed assignment based upon the real-time project completion updates; and
select a different project resource to compete the delayed assignment.

5. The computer system of claim 1, wherein the at least one processor is further programmed to:
transmit assignments to the resources; and
receive responses from the resources.

6. The computer system of claim 5, wherein the at least one processor is further programmed to:
determine one or more assignments that are declined based upon the responses from the resources; and
reassign the one or more declined assignments.

7. The computer system of claim 1, wherein the one or more update actions include at least one of replacing, modifying, and reinforcing existing equipment at the site.

8. The computer system of claim 1, wherein each cluster is based upon the travel distances between nearby sites so that a crew is able to update two or more sites in a single workday.

9. The computer system of claim 1, wherein a time for each update is based upon usage amounts for the site at different times of day.

10. The computer system of claim 1, wherein the plurality of sites are a plurality of wireless towers.

11. The computer system of claim 1, wherein the plurality of site information includes information about mounts and equipment at the sites.

12. A computer-implemented method for wireless structure update systems implemented by a computer system including at least one processor in communication with at least one memory device, the method comprising:
storing a plurality of site information;
receiving a request to update a plurality of sites, including a plurality of update parameters and an area containing the plurality of sites;
retrieving a plurality of site information for the plurality of sites;
comparing the plurality of site information to the plurality of update parameters;
determining one or more update actions to update each of the plurality of sites based upon the comparison;
calculating travel distance between nearby sites in the plurality of sites;
generating clusters for the plurality of sites, wherein each cluster is based upon the travel distances between nearby sites;
calculating an overall cost for the request to update based upon the determined one or more update actions, the travel distances, and the clusters;
assigning resources to the request to update based upon the overall cost, the determined one or more update actions, the travel distances, and the clusters;
receiving real-time project completion updates; and
updating the assigned resources based upon the real-time project updates.

13. The method of claim 12 further comprising:
storing a plurality of historical project information; and
calculating an overall cost for the request to update based upon the determined one or more update actions, the travel distances, the clusters, and the plurality of historical project information, including one or more weather predictions in the calculation of the overall cost.

14. The method of claim 12 further comprising:
determining a delayed assignment based upon the real-time project completion updates; and
selecting a different project resource to compete the delayed assignment.

15. The method of claim 12 further comprising:
transmitting assignments to the resources; and
receiving responses from the resources.

16. The method of claim 15 further comprising:
determining one or more assignments that are declined based upon the responses from the resources; and
reassigning the one or more declined assignments.

17. The method of claim 12, wherein the one or more update actions include at least one of replacing, modifying, and reinforcing existing equipment at the site.

18. The method of claim 12, wherein each cluster is based upon the travel distances between nearby sites so that a crew is able to update two or more sites in a single workday.

19. The method of claim 12, wherein a time for each update is based upon usage amounts for the site at different times of day.

20. The method of claim 12, wherein the plurality of sites are a plurality of wireless towers, wherein the plurality of site information includes information about mounts and equipment at the sites.
